(19) United States
(12) Patent Application Publication
(10) Pub. No.: US 2004/0177007 A1
(43) Pub. Date: Sep. 9, 2004

(54) Premium product access system for performance in a video game

(76) Inventor: Andrew S. Van Luchene, Santa Fe, NM (US)

Correspondence Address: Andrew Van Luchene, 229A Johnson Street, Santa Fe, NM, 87501, US

(21) Appl. No.: 10/793,621

(22) Filed: Mar. 3, 2004

Related U.S. Application Data
(60) Provisional application No. 60/451,608, filed on Mar. 3, 2003.

(51) Int. Cl. G06F 17/60; G06F 17/00

(52) U.S. Cl. 705/26; 463/1; 705/14; 705/27

(57) ABSTRACT

According to an aspect of the invention, it is determined that a particular performance has been achieved by a player of a video game. The video game is being run on a computer. In response to the particular performance, the player is allowed to obtain a product which is not obtainable without achieving certain performance of the video game.

The present application claims the benefit of priority of U.S. Provisional Patent Application Serial No. 60/451,608, entitled “Premium Product Access System for the Successful Completion of a Video Game”, filed Mar. 3, 2003, the entirety of which is incorporated by reference herein.

### BACKGROUND

Entertainment productions such as movies and video games often license the characters of those productions to product developers so that products such as toys can be manufactured and marketed.

For example, hundreds of toys were developed and made available based on the characters in the Star Wars® movies. Toys of Star Wars® characters can be purchased by anyone from any of a number of retailers. Some other toys of Star Wars® characters can be purchased only by mailing in the proofs-of-purchases from other Star Wars® toys.

It would be advantageous to provide improved systems for providing these and other such products.

### DESCRIPTION OF THE FIGURES

FIG. 1 is a block diagram of a network according to an embodiment of the invention.

FIG. 2 is a block diagram of a video game playing unit according to an embodiment of the invention.

FIG. 3 is a block diagram of a Player Information Database according to an embodiment of the invention.

FIG. 4 is a block diagram of a Product Purchase Code Database according to an embodiment of the invention.

FIG. 5 is a flow chart describing a Product Purchase Code activation method according to an embodiment of the invention.

FIG. 6 is a block diagram of a Central Server according to an embodiment of the invention.

FIG. 7 is a block diagram of a Product Purchase Code Database according to an embodiment of the invention.

FIG. 8 is a block diagram of a Product Database according to an embodiment of the invention.

FIG. 9 is a block diagram of a Registered Player Database according to an embodiment of the invention.

FIG. 10 is a block diagram of a Redeemed Product Purchase Codes Database according to an embodiment of the invention.

FIG. 11 is a flow chart describing a Product Purchase Code Redemption method according to an embodiment of the invention.

### DETAILED DESCRIPTION

The invention is described with reference to several embodiments. However, the invention is not limited to the embodiments disclosed, and those of ordinary skill in the art will recognize that the invention is readily applicable to many other diverse embodiments and applications.

In general, various embodiments of the invention allow a player of a video game (or other software) to be “rewarded” for particular performance that has been achieved. The video game is run on a video game playing unit (e.g., desktop computer, Sony PlayStation® computer, Microsoft Xbox® computer, handheld computer), and might be connected to an online multiplayer environment. In response to the particular performance, the player is allowed to obtain a product which is not obtainable without achieving certain performance of the video game.

Such “exclusivity” in products can motivate people to purchase and play video games. It would be advantageous to reward players (e.g., for completing certain aspects of a video game) by allowing such players to purchase products that are somewhat exclusive.

In one embodiment, a device (e.g., a computer running the video game, or a server which participates in an online multiplayer game) receives an indication that a particular performance has been achieved by a player of a video game. The device outputs a product purchase code to the player. This code may be redeemed for a product which is not obtainable without at least one product purchase code. For example, the product might not be available for sale except upon redemption of such a product purchase code.

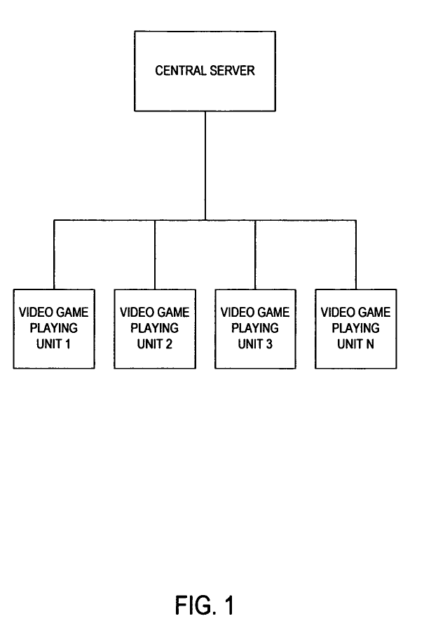

Referring to FIG. 1, a network according to one embodiment includes a central server in communication with a plurality of video game playing units. Those of ordinary skill in the art will appreciate that any number of video game playing units may be in communication with the central server. Similarly, more than one server may operate to coordinate the activities of the video game playing units, as is well known in the art.

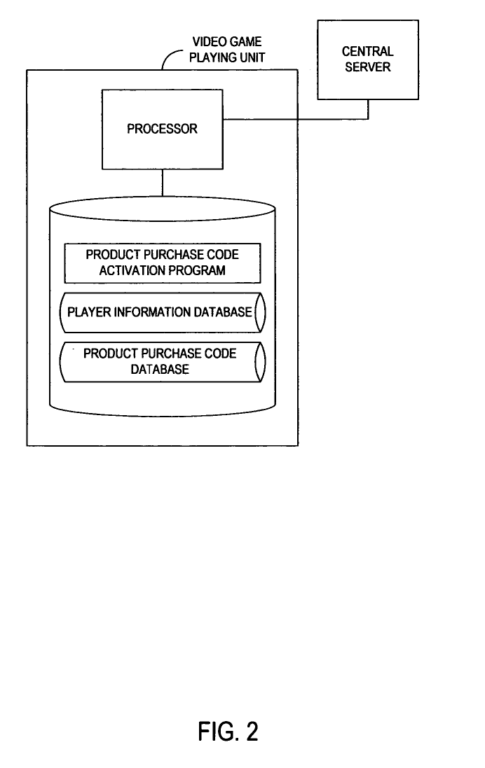

FIG. 2 shows a block diagram of an embodiment of a video game playing unit. The video game playing unit comprises a processor, such as an Intel Pentium® microprocessor, which is in communication with a storage device, such as an appropriate combination of RAM, ROM, hard disk, and other well known storage media. The storage device of this embodiment is illustrated as storing stores (i) a program (“product purchase code activation program”), (ii) a player information database, and (iii) a product purchase code database.

As would apparent to one of ordinary skill in the art, the information stored in databases described herein need not be stored on the video game playing unit, but may be stored, e.g., on the central server. Also, one of ordinary skill in the art would recognize that the databases described herein may be embodied in many different structures and may include many different types of data than the specific embodiments illustrated herein. Also, databases may be stored in compressed and/or encrypted formats, if desired. In fact, although the collections of data are referred to herein by the term “database”, a conventional database system need not be employed to store, alter and access the data referred to herein as stored in “databases”.

The program includes instructions that direct the processor to perform various functions, including the methods that are described herein and those which are apparent from the disclosure herein. As is well known to one of ordinary skill in the art, applicable programs may be generated in a wide variety of ways, and stored in a wide variety of formats—many other means are well know to one of ordinary skill in the art.

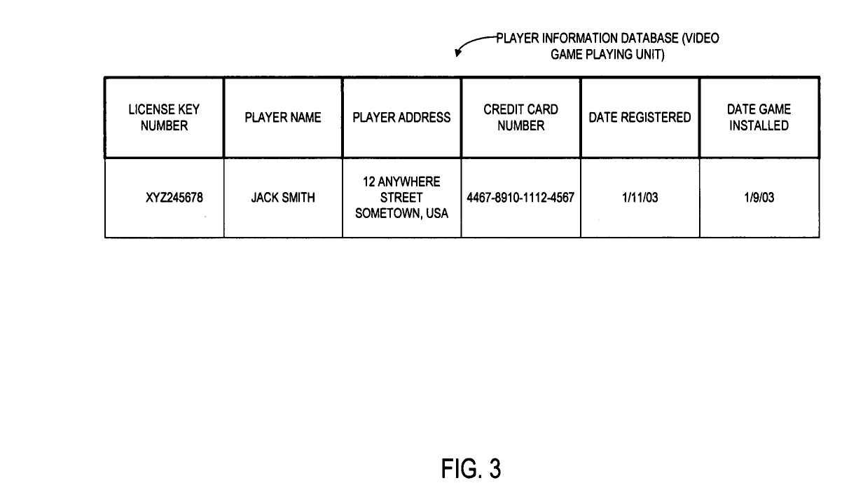

FIG. 3 illustrates an embodiment of a player information database. Each record of this database generally describes a player of a video game. The illustrated embodiment includes, for each record in the database, (i) a license key number, which is typically a unique alphanumeric code assigned to a unique copy of a video game or other software; (ii) a name of the player; (iii) an address of the player; (iv) a credit card number of a credit card account of the player; (v) the date on which the copy of the game or other software was registered; (vi) the date on which the copy of the game or other software was installed on the video game playing unit.

The player information database is typically stored as a file associated with the video game (e.g., in a folder with other files related to the video game). The player database (or portions thereof) may also be stored in other formats, such as partially distributed among other devices, or stored in a cookie file.

I. When Code is Issued

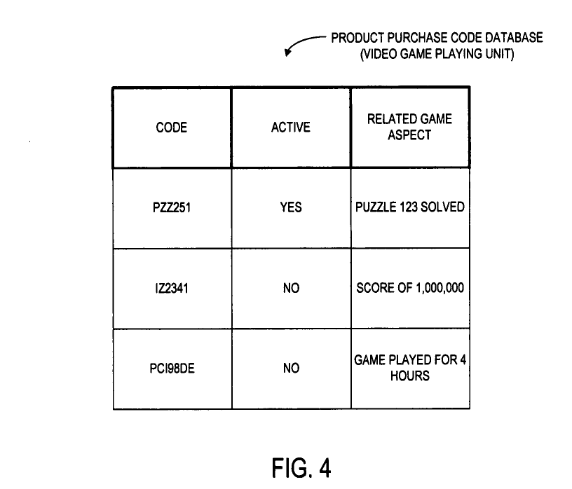

FIG. 4 illustrates an embodiment of a product purchase code database. Each record in the database represents (i) a product purchase code, (ii) an indication of whether the code is active, and (iii) a related game aspect which indicates particular performance which must be achieved to receive the product purchase code.

In this embodiment, the product purchase code database stores information related to product purchase codes that either are available (e.g., already awarded to the player) or may become available (e.g., upon achieving particular performance). Such data may be used to determine whether particular performance achieved by the player warrants any product purchase code. In some embodiments, such data may be used to determine whether any product purchase code is available for the particular performance achieved by the player (e.g., and can be “activated” if there are predetermined codes for particular performance).

Various types of performance may, when achieved, result in an ability to obtain a product that is not otherwise obtainable. The following list describes various types of performance, though many other types will be readily apparent to one of ordinary skill in the art:

Completing a game

Completing a game successfully

Completing certain puzzles or levels of a game

Achieving a certain score or scores

Playing a game for a certain amount of time

Playing a game a certain number of times

Defeating a certain number of opponents

Defeating a certain number of online opponents

Finding certain hidden objects (e.g., hidden codes)

Developing a character to a certain level

Any combination of the above

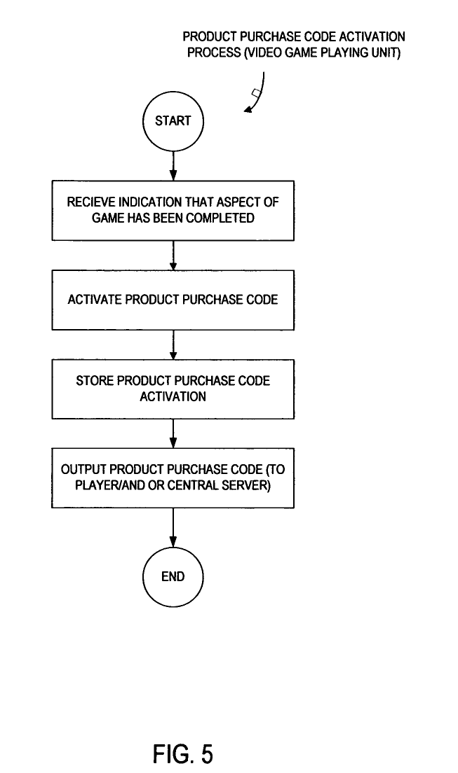

Referring to FIG. 5, the depicted flow chart generally illustrates an embodiment in which a product purchase code is “activated”. As shown, after receiving an indication that a particular performance has been achieved (e.g., an aspect of a game has been completed), a product purchase code is activated. This activation is stored (e.g., in a product purchase code database) and the code is output (e.g., to the player and/or the central server).

II. How Code is Issued

After receiving an indication that a particular performance has been achieved, the video game playing unit may provide the product purchase code (e.g., if the video game playing unit has access to the code). Alternatively, the video game playing unit may inform the central server that a particular performance has been achieved, and the server provides the code.

In one embodiment, the product purchase code is a unique code which may be used once. This can advantageously reduce the effects of cheating by, e.g., codes shared among more than one person. Several methods for providing single use codes in a software environment are well known and widely practiced.

Generally, a one-time use code is known (e.g., to a central server) so that such codes can be redeemed only once. One-time use codes may be known a priori (e.g., a table including one thousand twelve digit codes). Alternatively, one-time use codes may be unknown a priori, but are generated using a particular generating algorithm such that all such generated codes possess a certain property, but the codes even if examined will not easily reveal the algorithm.

One method for providing product codes would be to incorporate a random code generator into the video game software that generates one-time use codes and presents them to players who have successfully completed a certain aspect of a game.

Another method for providing product codes would be to associate codes with the software license key and software registration information of each individual copy of a game. In this embodiment, the product code given to a player could even be the same for more than one player. However, such a code might only be redeemed using a specific license key provided with each copy of the game. Accordingly, players would be motivated to buy copies of the game rather than borrow or copy it from their colleagues since they would not be eligible to redeem such codes. For example, if the player of a borrowed game completed certain aspects of a game, but a previous user had already used all the product purchase codes, the new player would be unable to redeem the corresponding product purchase codes.

Although several embodiments are discussed in which a “code” is involved, a code need never actually be displayed to the user. In fact, a representation of the code can suffice to be displayed to the player. Software (e.g., the video game, a utility program which is made available to players) can read the code, display to the player some representation of the code (e.g., its general worth, a product it is redeemable for). Accordingly, codes (whether or not displayed to the player) may be stored in a ‘wallet’ or account accessible by the player.

In one embodiment, after receiving an indication that a particular performance has been achieved, the player may be provided with an offer for a product. For example, the video game software itself can generate such an offer, or the central server might generate the offer. The offer can be output by the central controller (e.g., to the video game playing unit, emailed to an email address, posted on a web page accessible by he player, mailed to the player via postal mail). The offer can be output by the video game playing unit (e.g., via the video game software, a utility program or another means).

The video game software can output the offer to the player while the player is playing the video game (e.g., on a certain portion of the screen). Before receiving an offer, the player may first be informed that an offer is available (e.g., via email, a particular icon or other notification appears on the player's heads-up display during the video game). One so informed, the player may send a command to see the offer, and the offer is output accordingly.

In addition, although several embodiments are discussed in which a “code” is involved, a code need not be used to allow the player to obtain a product which is not obtainable without achieving certain performance. For example, upon achieving a particular performance, a player account could be credited with an amount of points or credits, which are redeemable for products not otherwise obtainable without achieving certain performance. Similarly, upon achieving a particular performance, a player could be provided with an offer to purchase a product not otherwise obtainable.

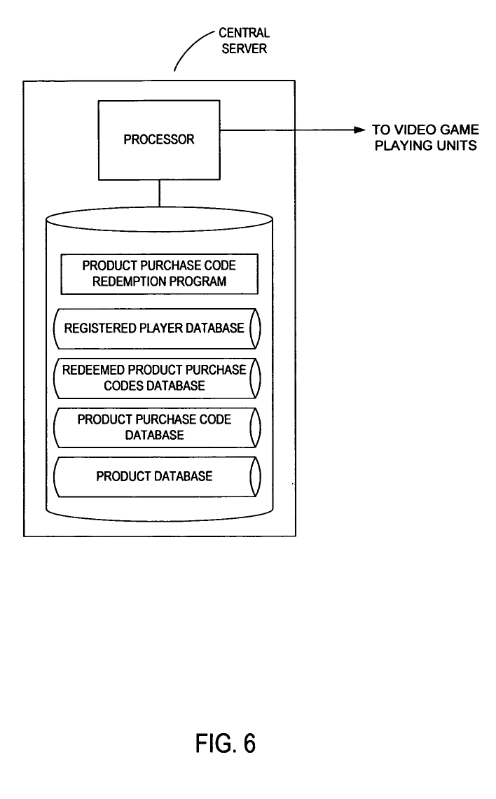

FIG. 6 shows a block diagram of an embodiment of a central server. The central server comprises a processor, such as an Intel Pentium® microprocessor, which is in communication with a storage device, such as an appropriate combination of RAM, ROM, hard disk, and other well known storage media. The storage device of this embodiment is illustrated as storing stores (i) a program (“product purchase code redemption program”), (ii) a registered player database, (iii) a redeemed product purchase codes database; (iv) a product purchase code database; and (v) a product database.

The program includes instructions that direct the processor to perform various functions, including the methods that are described herein and those which are apparent from the disclosure herein.

As would apparent to one of ordinary skill in the art, the information stored in databases described herein need not be stored on the central server, but may be stored, e.g., on a video game playing unit.

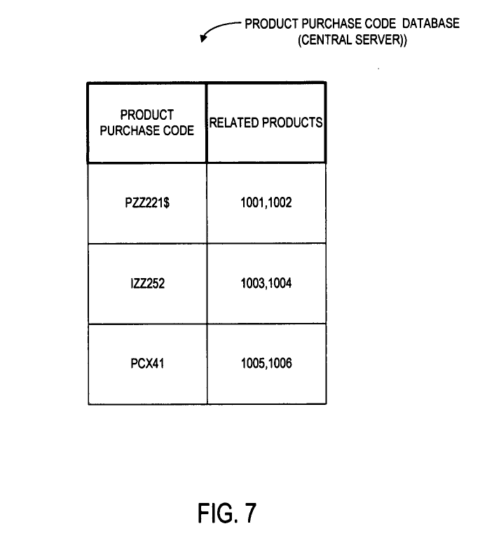

FIG. 7 depicts an embodiment of the product purchase code database. In the illustrated embodiment, each record indicates a code and one or more related products that may be obtained with that code. Accordingly, this information may be used to inform a player what products he may obtain.

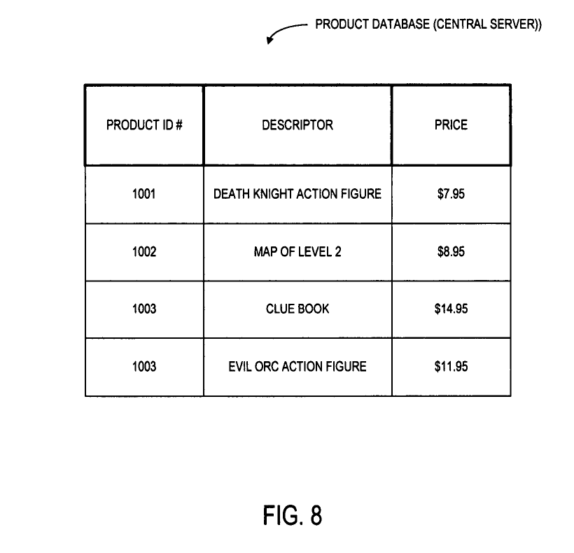

FIG. 8 depicts an embodiment of the product purchase database. In the illustrated embodiment, each record indicates details about a product, such as a description and a price. Such data may be used, e.g., in conjunction with the data illustrated in FIG. 7.

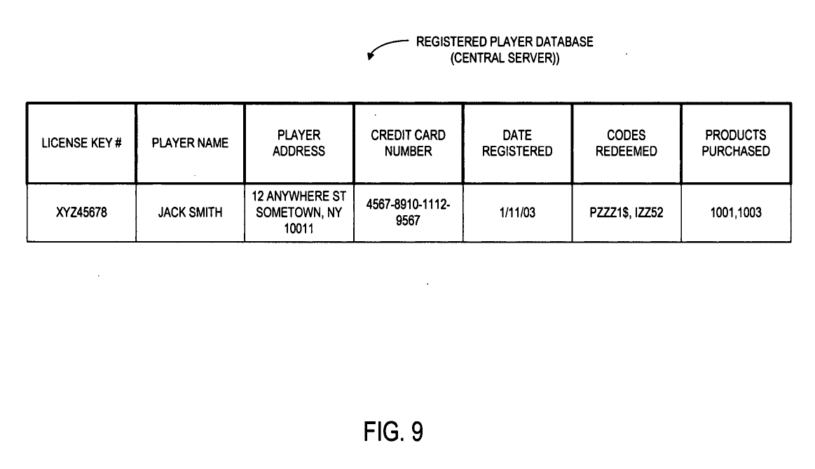

FIG. 9 depicts an embodiment of the registered player database. In the illustrated embodiment, each record indicates a player and his associated code redemption history. For example, each record indicates (i) the license key number, which is typically a unique alphanumeric code assigned to a unique copy of a video game; (ii) a name of the player; (iii) an address of the player; (iv) a credit card number of a credit card account of the player; (v) the date on which the copy of the game or other software was registered; (vi) codes which were previously redeemed; and (vii) products the player has previously obtained (e.g., purchased).

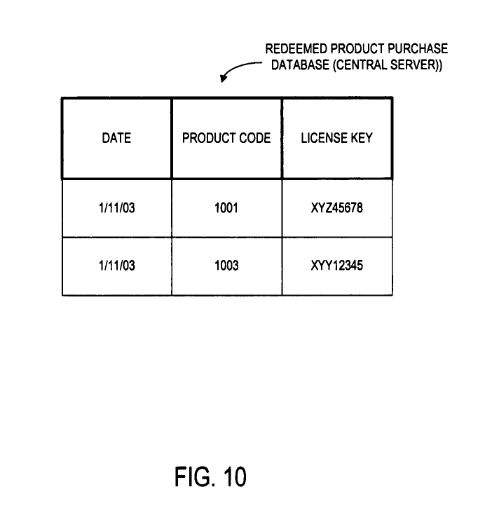

FIG. 10 depicts an embodiment of the redeemed product purchase codes database. In the illustrated embodiment, each record indicates (i) a date of redemption of the code; (ii) a product purchase code; and (iii) a license key of the software associated with the code (e.g., with obtaining the requisite performance in a video game). Thus the depicted data may be used to determine whether a product purchase code has already been redeemed (e.g., and thus should not be redeemed again).

III. How Code is Redeemed

Note that a product purchase code may not be what allows redemption per se. For example, the product purchase code might need to be used with other data (e.g., software license key) to obtain/purchase an item. Nevertheless, various embodiments described herein involve the use of a product purchase code as a means of direct redemption.

Product Purchase Codes may be redeemed in several ways. For example, the player may access a web site through a browser, or through the video game itself. In one embodiment, the player enters the code using appropriate mechanisms such as text entry in a field of a browser. In another embodiment, the code is transmitted to the web site (e.g., directly from the video game).

A Product Purchase Code may be provided over the phone to a live operator or to an automated response unit that receives and processes DTMF signals from the player's telephone.

A Product Purchase Code may be provided by being mailed in (e.g., on a post card). Such a post card could also indicate the desired product to obtain. Such an embodiment is advantageous where a catalog of available products and game completion requirements is included with the video game.

Many other ways of redeeming codes will be apparent to one of ordinary skill in the art.

A product purchase code may be associated with one product. For example, a particular product purchase code might only permit redemption of a particular product(s). The selection of product to be obtained upon redemption of a particular code could be (i) user selected (ii) random, and/or (iii) selected by device based on various rules (e.g., revenue management, scarcity management).

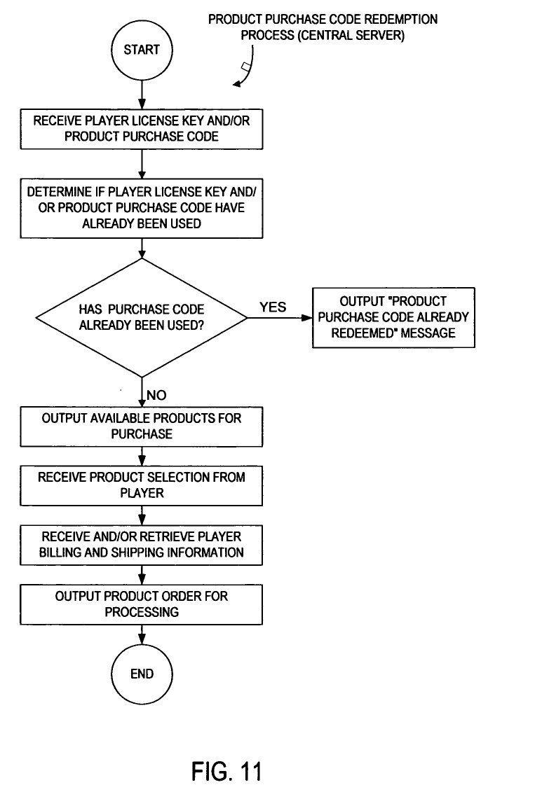

FIG. 11 is a flow chart describing a method according to an embodiment of the invention by which a Product Purchase Code is redeemed.

The central server receives a Product Purchase Code, as described above. The central server may determine if Product Purchase Code is valid. For example, the received code may be compared to all issued codes listed in a product purchase code database.

The central server may also determine if the Product Purchase Code has already been redeemed. For example, the received code may be compared to all codes listed in a redeemed product purchase codes database. If the Product Purchase Code is valid and has not been redeemed, one or more available product selections are output, as described above.

The player is provided an opportunity to select a product in any of a variety of ways known in the art. Upon receiving an indication of the player's selection, the central server accesses the player's payment and shipping information. For example, the player may provide such information, or such information may be retrieved from an account of the player (e.g., an account used to pay for monthly access to an online gaming environment). The order for the product is then processed for delivery to the player.

IV. Products

Many types of products can be provided through the methods described herein. For example, it would be advantageous to provide toys which are related to characters of the video game and/or related to particular aspects of a game that were completed to get a code. In addition, it would be advantageous to provide products that enhance the game experience, such as clue books and maps which, e.g., allow the player to defeat other aspects of the game and thus obtain additional codes. In one embodiment, it could be impossible to achieve certain performance (e.g., reach the next level of a game) without the use of the certain products that can only be obtained by redeeming Product Purchase Codes generated earlier in the game.

The product for which a code is redeemed could be based on the redemption of other players. For example, the first player to redeem a product purchase code for a particular game could be given access to an even more exclusive product or group of products than subsequent players redeeming a code. Such an embodiment would motivate players to submit purchase codes before other players. In such an example, only the first player (or only the first predetermined number of players) to accomplish a certain objective or objectives would be able to purchase a particular product or group of products.

In one embodiment, a product purchase code provides “purchasing rights” to tiers of products. For example, a single product purchase code could allow the player to purchase one product from a group of products, or any or all of the products in a particular group. Similarly, payment by the player of a certain license fee (e.g., gold level account) could determine whether the player may redeem a certain product purchase code only once or a number of times.

As described herein the product which may be obtained enjoys “exclusivity”. For example, one cannot obtain/purchase the product without having a code; one cannot obtain the product unless they have achieved certain performance in the game; and/or one cannot obtain the product unless they have achieved certain types of performance in the game.

In one embodiment, exclusivity may be limited. For example, there may be a two year time period during which a certain product is only sold through redemption of codes, but thereafter the product can be purchased in other ways (e.g., through conventional retail, through a web site that does not require code redemption).

The product (which may only be obtained by using code) may be a non-unique product which is altered in some way (e.g., engraved, dyed). In other words, the product need not be custom mass-produced.

The codes could be personalized with the players name and rank to provide even more exclusivity.

Product Purchase Codes could be used to allow a player to have a certain status in an online environment. For instance, obtaining the code could allow a player to own virtual property in a game. New players might not be able to own property in the game without obtaining the product purchase code. A new player might be forced to, e.g., work for a player who has a product purchase code until the new player obtained a product purchase code for himself. Thus, players with product purchase codes could have a greater status in the online video game than players without such codes.

Product purchase codes could be sold from one player to another. For example, a web page may allow the owners of product purchase codes to post those codes, and possibly with other information such as a desired sale price for the code, minimum sale price for the code, etc.

What is claimed is:

1. A method comprising:
receiving an indication that a particular performance has been achieved by a player of a video game;
outputting a product purchase code to the player;
receiving the product purchase code from a user after the step of outputting the product purchase code to the player; and
allowing the user to obtain a product which is not obtainable without at least one product purchase code.

2. The method of claim 1, further comprising:
determining whether the particular performance achieved by the player of the video game warrants any product purchase code.

3. The method of claim 2, further comprising
determining whether any product purchase code is available for the particular performance achieved by the player of the video game.

4. The method of claim 1, further comprising:
generating the product purchase code.

5. The method of claim 4, wherein generating a unique product purchase code comprises:
generating a unique product purchase code based on the particular performance.

6. The method of claim 5, further comprising:
selecting the product purchase code from a plurality of product purchase codes based on the particular performance.

7. The method of claim 1, wherein the user is the player.

8. The method of claim 1, in which outputting a product purchase code to the player comprises:
commanding a device to output the product purchase code.

9. The method of claim 1, in which commanding a device to output the product purchase code comprises:
establishing communications with a software application running on a computer; and
transmitting first data to the software application.

10. The method of claim 1, in which outputting a product purchase code to the player comprises:
outputting a first code to the player, in which the first code is capable of being used to generate the product purchase code.

11. The method of claim 1, further comprising:
verifying the particular performance.

12. The method of claim 11, in which verifying the particular performance comprises:
verifying that the particular performance was achievable in the video game.

13. The method of claim 1, further comprising:
determining payment information for the product.

14. The method of claim 13, in which the step of determining payment information and shipping information comprises:
determining an account of the player; and
determining a credit card number of the player from the account.

15. The method of claim 1, further comprising:
processing an order for the product.

16. The method of claim 1, further comprising:
outputting, in response to the received indication, an offer for a product.

17. The method of claim 16, in which the step of outputting the offer comprises:
outputting the offer while the player is playing the video game.

18. The method of claim 16, further comprising:
storing an indication of the offer; and
performing the step of outputting the offer upon receiving a command from the player.

19. A method comprising:
determining that a particular performance has been achieved by a player of a video game that is being run on a computer;
outputting a product purchase code to the video game running on the computer;
receiving the product purchase code from the computer;
after receiving the product purchase code, allowing the player to obtain a product which is not obtainable without at least one product purchase code.

20. A method comprising:
determining that a particular performance has been achieved by a player of a video game that is being run on a computer; and
in response to the particular performance, allowing the player to obtain a product which is not obtainable without achieving certain performance of the video game.
